(19) United States
(12) Patent Application Publication
(10) Pub. No.: US 2012/0271968 A1
(43) Pub. Date: Oct. 25, 2012

(54) LOGIC DEVICE FOR COMBINING VARIOUS INTERRUPT SOURCES INTO A SINGLE INTERRUPT SOURCE AND VARIOUS SIGNAL SOURCES TO CONTROL DRIVE STRENGTH

(75) Inventors: Kevin Lee Kilzer, Chandler, AZ (US); Sean Steedman, Phoenix, AZ (US); Jerrold S. Zdenek, Riverside, IL (US); Vivien N. Delport, Chandler, AZ (US); Zeke Lundstrum, Chandler, AZ (US); Fanie Duvenhage, Phoenix, AZ (US)

(73) Assignee: Microchip Technology Incorporated

(21) Appl. No.: 13/450,079

(22) Filed: Apr. 18, 2012

Related U.S. Application Data
(60) Provisional application No. 61/477,780, filed on Apr. 21, 2011.

(51) Int. Cl. G06F 13/14

(52) U.S. Cl. 710/12

(57) ABSTRACT

A processor includes a RISC CPU core and a plurality of peripherals including a configurable logic cell peripheral. The configurable logic cell peripheral may be configured to combine a plurality of inputs into a single output. The configurable logic cell may be programmable to function as one of a plurality of predetermined logic functions.

### CROSS-REFERENCE TO RELATED APPLICATIONS

This invention claims priority from U.S. Provisional Patent Application Ser. No. 61/477,780, filed Apr. 21, 2011, titled “A Logic Device for Combining Various Interrupt Sources Into a Single Interrupt Source and Various Signal Sources to Control Drive Strength,” which is incorporated herein it its entirety. This application is related to co-pending U.S. patent application Ser. No. 13/449,687, filed on Apr. 18, 2012, entitled “Selecting Four Signals From Sixteen Inputs”; U.S. patent application Ser. No. 13/449,850, filed on Apr. 18, 2012 entitled “Configurable Logic Cells”; and U.S. patent application Ser. No. 13/449,993, filed on Apr. 18, 2012 entitled “Configurable Logic Cells”, all filed concurrently herewith and incorporated by reference in their entirety.

### BACKGROUND OF THE INVENTION

1. Field of the Invention

The present disclosure relates to configurable logic cells, and, more particularly, to a logic device for combining 1) various interrupt sources into a single source and 2) various signal sources to control drive strength.

2. Description of the Related Art

Modern microprocessors and microcontrollers include a number of interrupt sources, but typically these are all singular in nature. For example, the timer interrupt comes exclusively from the timer, and the I/O interrupt comes exclusively from the I/O pin. In many situations, however, a combination of signals is required in order to cause (or prevent) an interrupt from occurring, and this is generally done using software or programmed state machine-like operations with considerable complexity and expense. Such systems are notoriously hard to write and debug.

Additionally, modern microprocessors include a number of outputs that are sourced by various subsystems or I/O control registers. Typically, a dedicated register (bit) is provided to control the drive strength (a.k.a. slew rate) of an I/O pin, or to disable (tri-state) the output which again, can require considerable complexity and expense.

### SUMMARY OF THE INVENTION

These and other drawbacks in the prior art are overcome in large part by a system and method according to embodiments of the present invention.

A processor in accordance with embodiments as claimed includes a RISC CPU core and a plurality of peripherals including a configurable logic cell peripheral. The configurable logic cell peripheral may be configured to combine a plurality of inputs into a single output.

In some embodiments, the plurality of inputs comprise I/O ports, oscillator output, system clocks, or peripheral outputs and the single output comprises an I/O port, a peripheral input, or a system clock. In some embodiments, the single output controls drive strength at an output port. In some, the single output controls slew rate at an output port.

In some embodiments, the configurable logic cell may be programmable to function as one of a plurality of predetermined logic functions. The configurable logic cell peripheral may be configurable via one or more software registers or via non-volatile memory.

Such a non-volatile memory may be statically connected for configuration. In some embodiments, the non-volatile memory may be read and configuration data transferred to configuration registers for configuring the configurable logic cell peripheral. In some embodiments, after initial configuration, the configuration of the configurable logic cell peripheral can be updated via software.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 illustrates an exemplary integrated circuit including a configurable logic cell.

FIG. 2 illustrates an exemplary data and address lines in an integrated circuit including a configurable logic cell.

FIG. 3 illustrates an exemplary module including a configurable logic cell.

FIG. 4A and FIG. 4B illustrate software control and configuration of a configurable logic cell.

FIG. 5A and FIG. 5B illustrate exemplary logic functions for a configurable logic cell that replaces two statically configured functions with a single, software-controlled function.

FIG. 6A-FIG. 6D illustrate logic function combinatorial options for an exemplary configurable logic cell.

FIG. 7A-7D illustrate logic function state options for an exemplary configurable logic cell.

FIG. 8 illustrates an exemplary JK flip flop application and timing implemented with an exemplary configurable logic cell.

FIG. 9 is a diagram of an exemplary integrated circuit pin configuration.

FIG. 10 illustrates exemplary output register usage for a plurality of configurable logic cells.

FIG. 11 illustrates exemplary cascading of configurable logic cells.

FIG. 12 illustrates use of a configurable logic cell to combine interrupt requests.

FIG. 13 illustrates use of configurable logic cells to control port properties.

### DETAILED DESCRIPTION

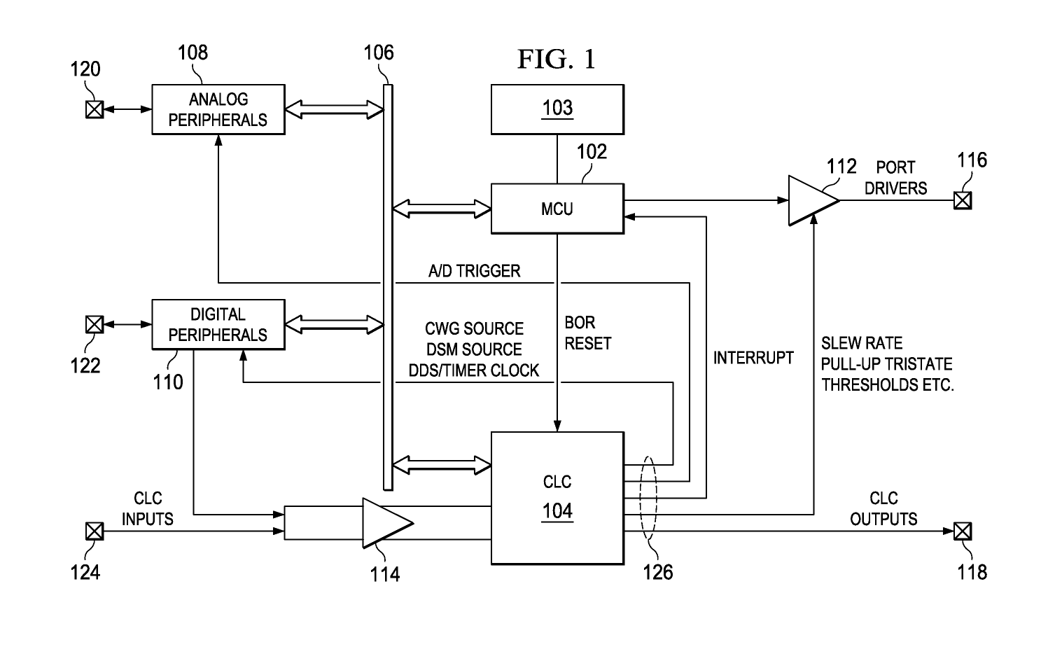

Turning now to the drawings and, with particular attention to FIG. 1, a diagram of a processor or microcontroller 100 according to an embodiment of the present invention is shown. The processor 100 includes a processor core (MCU) 102, which may be embodied as a RISC core. The processor core 102 couples via a bus 106 to one or more on-chip peripheral devices, such as analog peripherals 108 and digital peripherals 110. The processor 100 may further include one or more on chip memory devices 103, which may be implemented as programmable flash memory.

In addition, as will be explained in greater detail below, the processor 100 further includes one or more configurable logic cells (CLC) 104, functioning as peripheral devices and coupled to the bus 106. That is, the configurable logic cells 104 are addressable like other peripheral devices and provide logic functions for the system. As will be discussed in greater detail below, the configurable logic cells 104 are programmable to implement a variety of logic functions. These can include, for example, AND, OR, XOR functions, and D, JK, and SR storage.

The processor 100 further includes one or more input and/or outputs 116, 118, 120, 122, 124, and associated port drivers, input controls 114, etc.

In the embodiment illustrated, the configurable logic cell 104 receives inputs from external pin 124, digital peripherals 110, and a reset from the processor core 102. These can include, for example, Complementary Waveform Generator (CWG) source, Data Signal Modulator (DSM) source, and Direct Digital Synthesis (DDS)/Timer clock inputs. In general, inputs can come from I/O pins, register bits, other peripherals, and internal clocks.

In addition, the configurable logic cell 104 can provide digital outputs to one or more of the analog peripherals 108, the digital peripherals 110, and the processor core 102. Additional outputs (such as slew rate, pull-up tristate thresholds, etc.) can be provided to port drivers 112, while others can be provided to external pins 118.

Thus, in general, the configurable logic cell 104 can receive inputs from any subsystem such as a digital peripheral, I/O port, or internal status bits, or reset signals, including for example, oscillator output, system clocks, etc., and provides outputs to I/O pins, peripherals, a processor core interrupt, I/O port control functions, status signals, system clock, and even to other configurable logic cells (not shown).

As noted above, in some embodiments, the configurable logic cell 104 is addressed like other peripheral devices and may be configured at run-time. In some embodiments, the configurable logic cell 104 may be configured at run time using one or more special function registers (not shown). Thus, the configurable logic cell 104 is fully integrated into the processor address and data bus. Configuration can be applied statically or updated in real time based on the needs of the application.

In some embodiments, configuration of the configurable logic cell 104 can come from software registers or non-volatile memory. In some embodiments, the memory may be read and data transferred to configuration registers. In others, the memory may be statically connected for configuration (as in generic logic arrays/programmable logic arrays (GAL/PAL)). Further, in some embodiments, after an initial configuration, software may update the configuration.

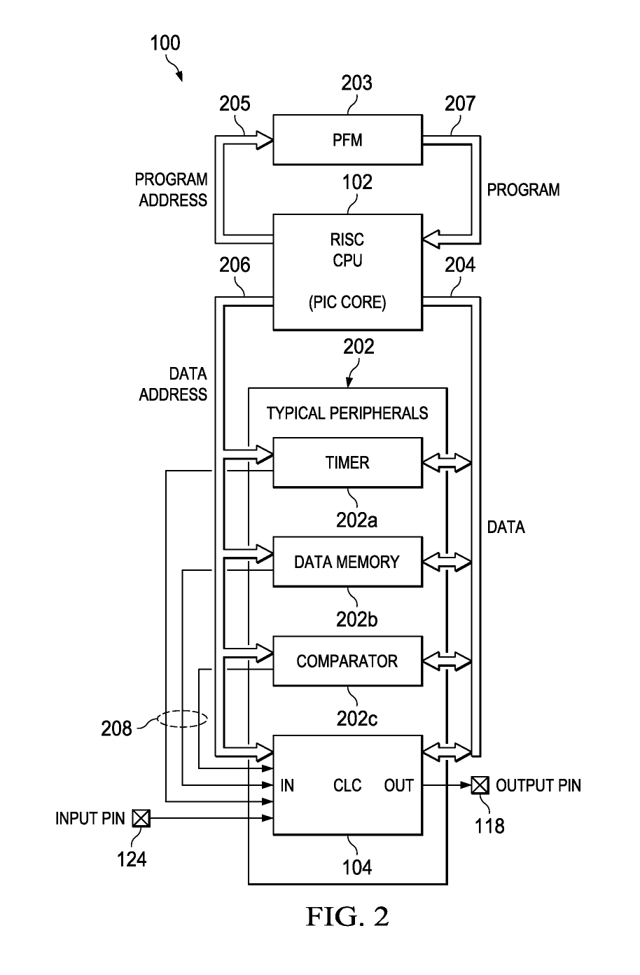

As such, in some embodiments, system signals and I/O signals are routed to the configurable logic cell 104, as shown in FIG. 2. The configurable logic cell 104 then performs the configured logic and provides an output. In particular, shown in FIG. 2 is processor 100 including processor core 102, a program flash memory 203, and peripherals 202. The program flash memory 203 couples via program address lines/bus 205 and program data lines/bus 207 to the processor core 102.

In the example illustrated, the peripherals include a timer 202a, data memory 202b, a comparator 202c, and the configurable logic cell 104. The peripherals couple to the processor core 102 by data address lines/bus 206 and data lines/bus 204. The configurable logic cell 104 may receive further individual inputs from the peripherals 208 or from an input pin 124. Thus, software and other peripherals can supply inputs to the configurable logic cell 104. The configurable logic cell 104 performs a configured logic operation and provides an output 312.

As noted above, the configurable logic cell implements one or more logic functions and can do so independently of the status of the processor core, e.g., while the processor core is in a sleep or debug mode. As will be discussed in greater detail below, the configurable logic cell includes Boolean logic programmable to implement a variety of functions, such as single gates, multiple gates, flip-flops, etc.

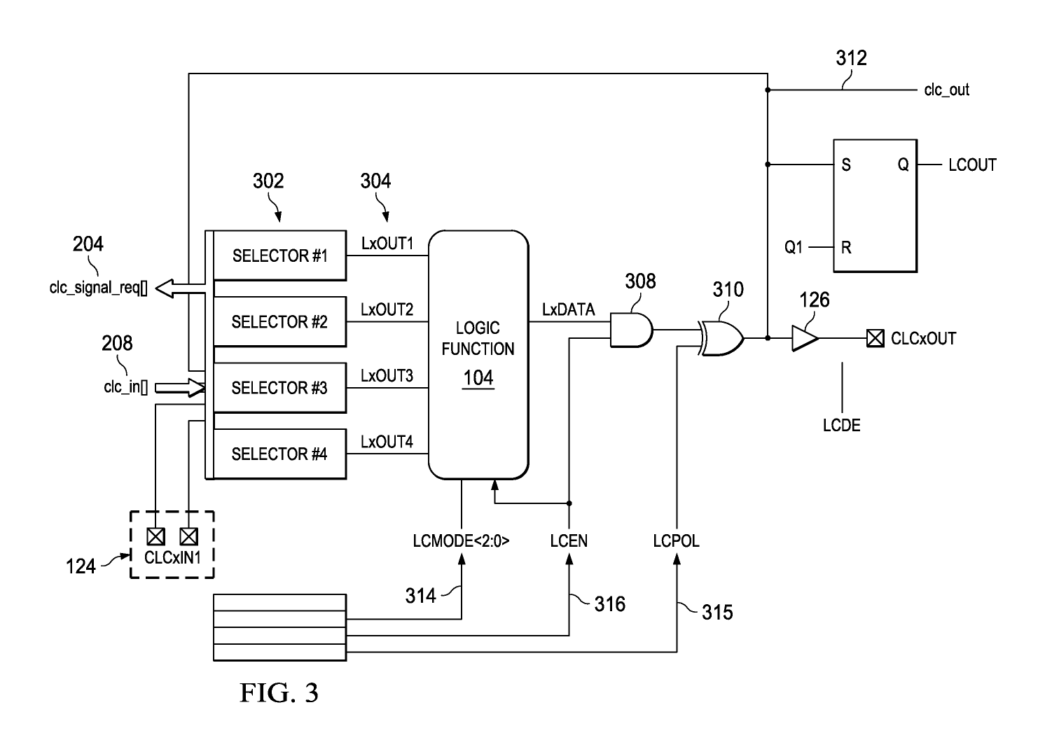

FIG. 3 illustrates the configurable logic cell environment according to one embodiment more particularly. Configurable logic cell 104 receives four channel inputs 304 L×OUT1, L×OUT2, L×OUT3, and L×OUT4 from a plurality of selectors 302. Inputs to the selectors 302 can come from signals 208 and I/O 124. In some embodiments, the selectors are multiplexers and/or configurable gates. For example, in some embodiments, the selectors 302 can reduce the number of inputs cic in 208 from eight to four 304 to drive one of eight selectable single-output functions. Further details on particular implementations of the selectors 302 may be found in commonly-assigned, co-pending patent application Ser. No. ______, titled “Selecting Four Signals from Sixteen Inputs,” filed Apr. 17, 2012, which is hereby incorporated by reference in its entirety as if fully set forth herein.

In the example illustrated, the configurable logic cell 104 receives control inputs LCMODE<2:0> 314 and LCEN 316 from one or more control registers 315. The output L×DATA of the configurable logic cell 104 is ANDed with the LCEN input 316. The output of AND gate 308 is XORed with LCPOL a control signal from a control register 315 and then output as CLC×OUT, all of which are explained in greater detail below.

As noted above, embodiments allow for real time configuration of the configurable logic cell. That is, configuration is provided through registers accessible from the microprocessor and can be updated based, for example, on external inputs, time of day, temperature of the system, coincidence with other events, or commands from a remotely controlling host.

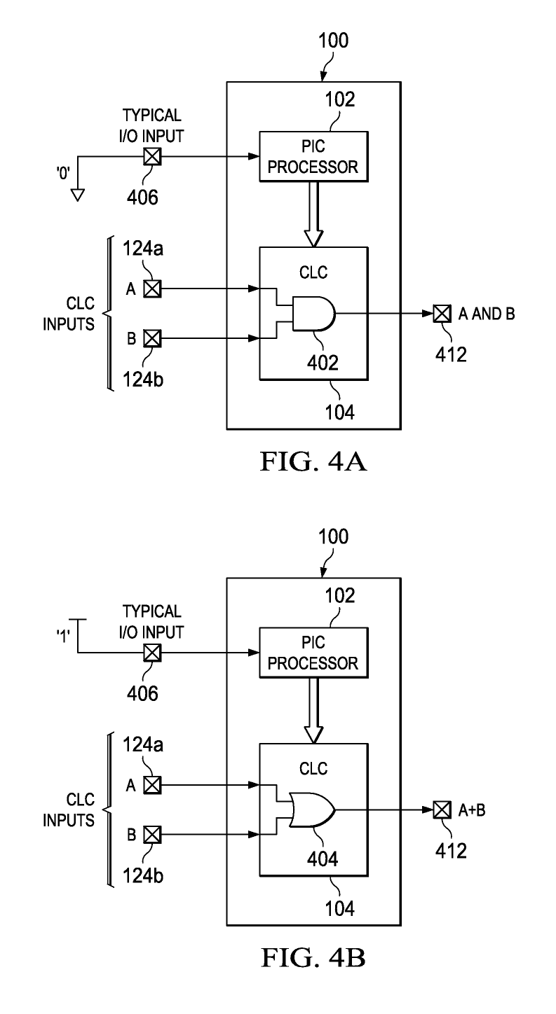

FIG. 4A and FIG. 4B schematically illustrate such operation. In particular, shown is processor 100 including processor core 102 and configurable logic cell 104. The processor 100 has an I/O input 406 to the processor core 102 and a pair of inputs 124a, 124b to the configurable logic core 104. The configurable logic cell 104 outputs to pin 412.

In operation, the state of the I/O pin 406 can be used to set the configurable logic core function. In the example illustrated, when the logic state of the I/O input 406 is “0”, the processor core 102 writes to one or more registers (such as the L×Mode register 314 of FIG. 3) to cause the configurable logic cell 104 to implement an AND function 402, so that the outputs on pin 412 is the logical AND of inputs A 124a and B 124b (AB). In contrast, when the logic state of the I/O input 406 is “1”, the processor core 102 writes to one or more registers to cause the configurable logic cell 104 to implement an OR function 404, so that the output on pin 412 is the logical OR of inputs A 124a and B 124b (A+B). As can be appreciated, once the functions are set, the configurable logic cell 104 implements the configured function regardless of the functioning of the processor core 102.

Advantageously, the configurable logic cell 104 of embodiments of the present invention allows for dynamic configuration and direct access to software, allowing software to reconfigure individual gates and inverters while the system is running. That is, the configurable logic cell of embodiments of the invention allows real-time software access to internal configuration and signal paths, without requiring a microprocessor interface.

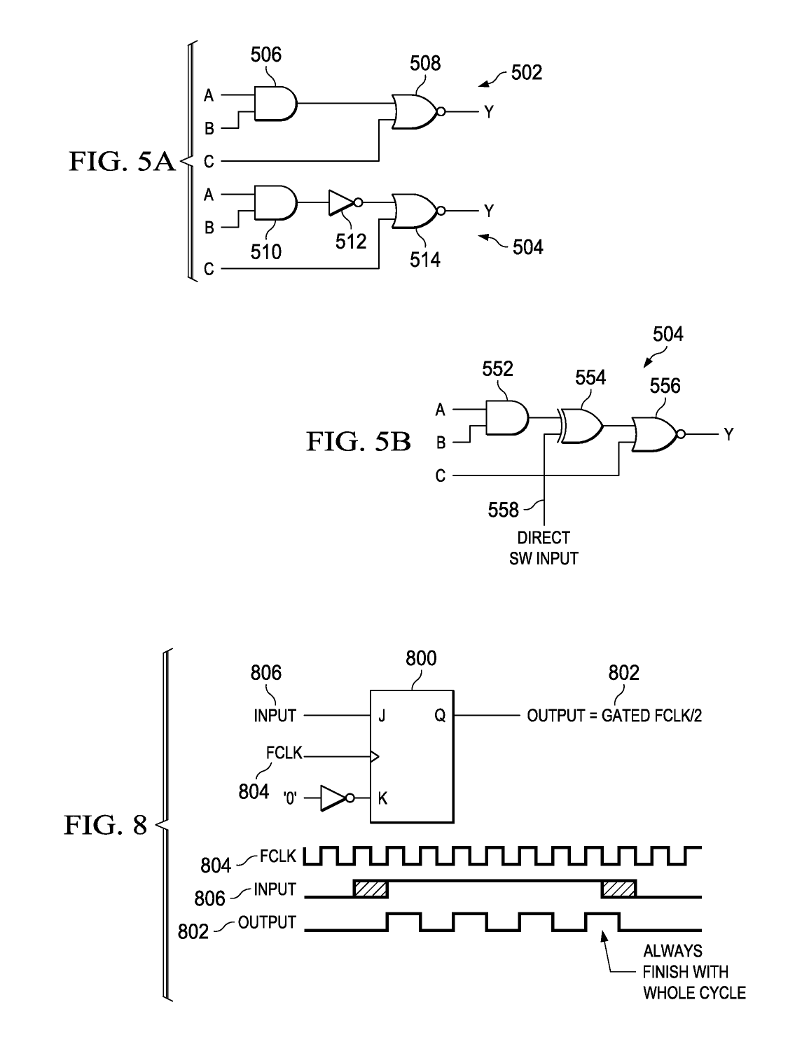

For example, as shown in FIG. 5A, a static configuration of a microprocessor interface for implementing the two functions ((A*B)+C)′ and ((A*B)′+C)′ requires two versions 502, 504, including AND gates 506, 510, NOR gates 508, 514, and inverter 512.

In contrast, an exemplary configurable logic cell 104 for implementing the functions is shown in FIG. 5B. The configurable logic cell 104 includes AND gate 552, XOR gate 554, and NOR gate 556. Inputs A and B are provided to AND gate 552, while input C is provided to the NOR gate 556. The output of the AND gate 552 is provided to the XOR gate 554, while the XOR gate 554 provides its output to the input of NOR gate 556. In addition, a direct software (SW) input 558 (e.g., from a control register) is provided to the input of the XOR gate 554. In this way, both functions of circuits 502, 504 are implemented using a single circuit and yet allowing direct software control.

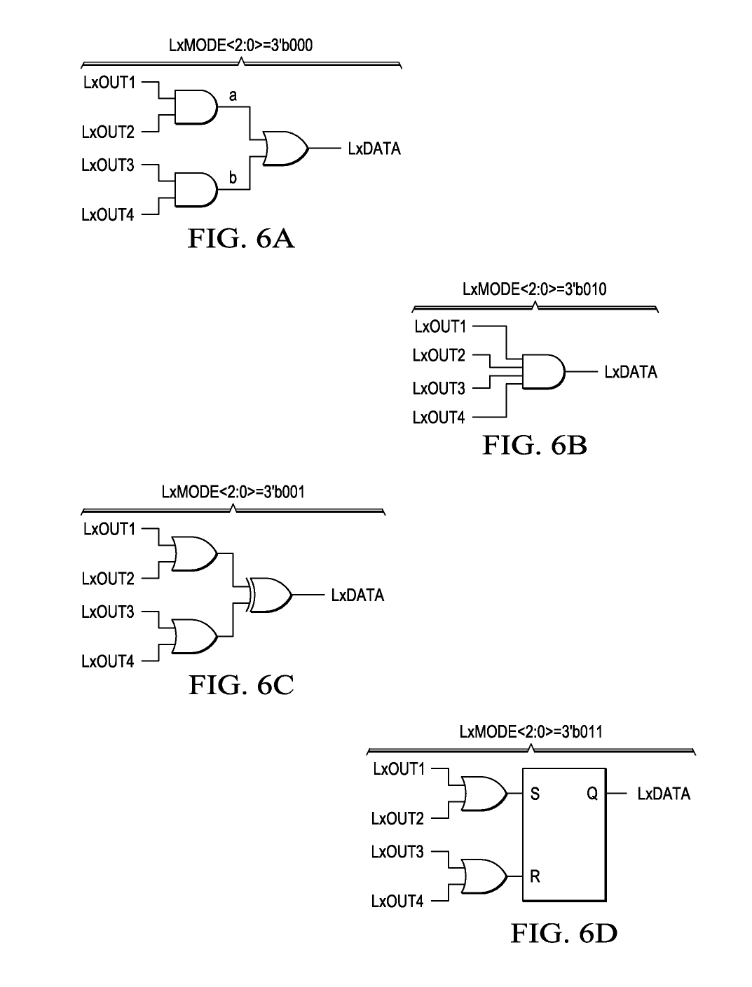

Exemplary combinatorial options for a particular four-input configurable logic cell are shown in FIG. 6A-6D. More particularly, in some embodiments, a L×MODE<2:0> configuration register 314 (FIG. 3) defines the logic mode of the cell. When L×MODE=000, the configurable logic cell implements an AND-OR function. When L×MODE=001, the cell implements an OR-XOR function. When L×MODE=010, the cell implements an AND; when L×MODE=011, the cell is an RS latch.

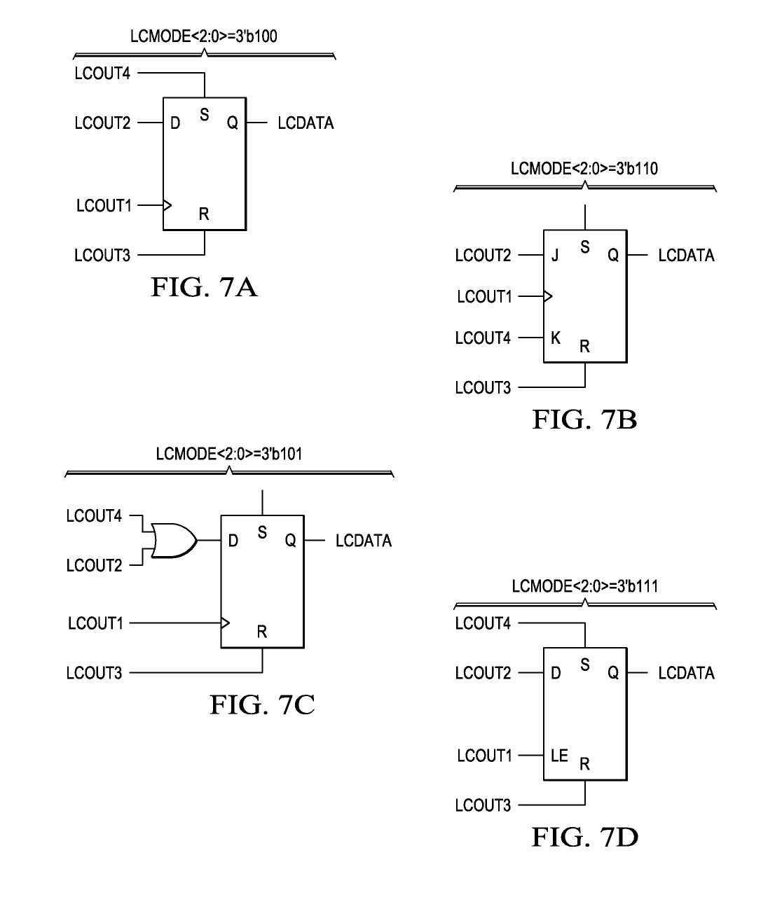

Correspondingly, the configurable logic cell 104 may incorporate a plurality of state logic functions. These are shown with reference to FIG. 7A-7D. The state functions include both D (FIG. 7A) and JK flipflops (FIG. 7B) with asynchronous set (S) and Reset (R). Input channel 1 (LCOUT1) provides a rising edge clock. If a falling edge is required, channel 1 (LCOUT1) can be inverted in the channel logic (not shown). Input channel 2 (LCOUT2), and sometimes channel 4 (LCOUT4), provide data to the register or latch inputs.

When LCMODE=100, the cell implements a one input D flipflop with S and R. When LCMODE=101, the cell implements a two input D flipflop with R. When LCMODE=110, the cell implements a JK flipflop with R. When LCMODE=111, the cell implements a one input transparent latch with S and R (The output Q follows D while LE is low and holds state while LE is high).

FIG. 8 illustrates an example operation of a JK flip-flop in accordance with embodiments of the invention. In particular, shown is a clock gating example including a JK flip flop 800, with input 806, output 802, and clock 804. The output 802 is a gated FCLK/2.

The JK flipflop can be configured according to FIG. 7B, with the clock at LCOUT1, J input at LCOUT2, and K input (inverted) at LCOUT4. As can be seen, the output 802 always includes a whole number of cycles. It is noted that other logic and state functions can be implemented. Thus, the figures are exemplary only.

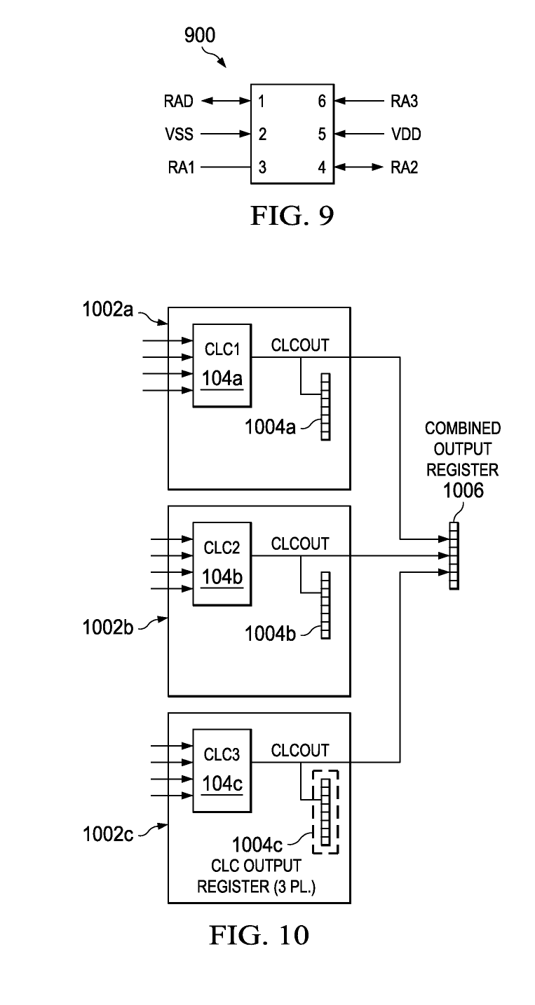

As noted above, in some embodiments, each configurable logic cell 104 has four inputs selectable from a constellation of eight available signals, and one output, although other numbers of signals and inputs are possible. In some embodiments, however, the integrated circuit package includes only four input-output pins. That is, the integrated circuit package includes one pin for output and three for input. This is shown by way of example in FIG. 9, integrated circuit 900 includes pins RA0, RA1, RA2, RA3, Vss and Vdd. RA0-RA2 may be inputs, for example, and RA3 may be the output. Other inputs to the configurable logic cell 104 come from other peripherals on the internal data bus. In some embodiments, in which the integrated circuit includes more than one peripheral logic cell, inputs can come from other peripheral logic cells, as will be discussed in greater detail below. It is noted that different package configurations could be employed. Furthermore, the configurable logic cells could have more or fewer inputs and outputs than specifically shown. Thus, the figure(s) is exemplary only.

In implementations including more than one peripheral logic cell 104, it may desirable for the software to be able to read multiple cell outputs substantially simultaneously.

Consequently, in accordance with embodiments of the present invention, a combined output register may be provided. This is shown in FIG. 10, which illustrates three configurable logic units 1002a, 1002b, 1002c. It is noted that more or fewer than three may be provided. Thus, the figures are exemplary only.

Each configurable logic unit 1002a, 1002b, 1002c includes a configurable logic cell 104a, 104b, 104c, respectively. Each further includes an output CLCOUTA, CLCOUTB, CLCOUTC, respectively. In implementations in which only one configurable logic cell is employed, the output is provided to an associated output register 1004a, 1004b, 1004c, respectively.

However, when more than one configurable logic cell is in use, the outputs are additionally provided to the common register 1006, outside the configurable logic unit instances. That is, the output register 1006 contains mirror copies of the contents of the individual output registers 1004.

The register 1006 is configured such that the outputs of the configurable logic cells are all sampled at the same time. By providing the combined output register 1006 outside the instances of each of the logic units, their combined outputs may be read substantially simultaneously.

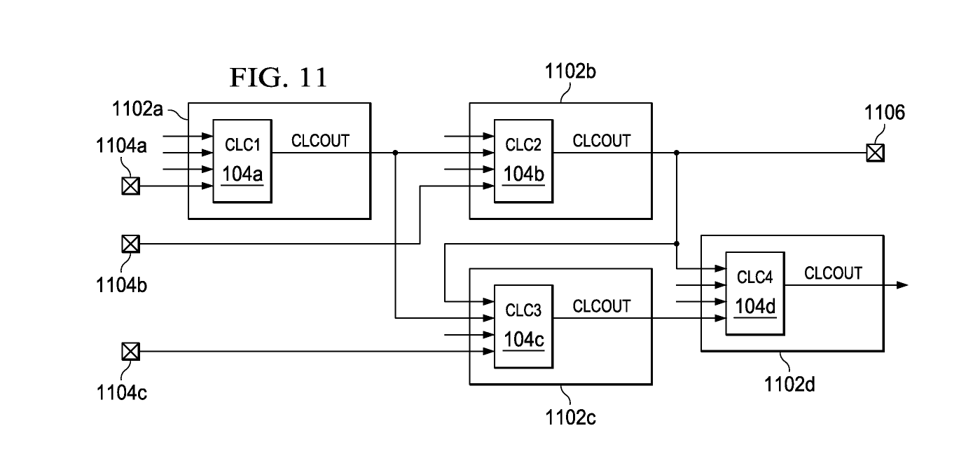

In addition, by providing multiple configurable logic cells having inputs other than external pins, the cells can be cascaded to create complex combinations. This is shown by way of example in FIG. 11.

In particular, shown in FIG. 11 is a system 1100 including a plurality of configurable logic units 1102a, 1102b, 1102c, 1102d, each including a corresponding configurable logic cell 104a, 104b, 104c, 104d, respectively. As shown, the configurable logic cell 104a provides its output to configurable logic cell 104b and 104c, while configurable logic cell 104b provides outputs to an external pin 1106 as well as to inputs of configurable logic cell 104c and configurable logic cell 104d. In addition, the configurable logic cell 104d provides its output to an output line, e.g., to another peripheral or to the processor core.

As can be seen each of the configurable logic cells 104a, 104b, 104c, 104d has four inputs and can receive input signals from input pins 1104a, 1104b, 1104c, from other configurable logic cells, or from other on-chip and peripheral devices.

It is noted that, while four peripheral logic cells are shown in a particular configuration, in practice the numbers and the configurations can vary. Thus, the figure is exemplary only.

As noted above, the configurable logic cell 104 can receive inputs from I/O pins or other peripheral outputs, and provides outputs to I/O pins, peripherals, a processor core interrupt, I/O port control functions, and even to other configurable logic cells.

Advantageously, the configurable logic cell 104 may be used to combine a plurality of available interrupt sources using a logic function, latch or flip-flop, and produce a single interrupt to the microprocessor. For example, a timer interrupt can be blocked when an external signal is at a logic ‘0,’ and allowed when the signal is at a logic ‘1.’

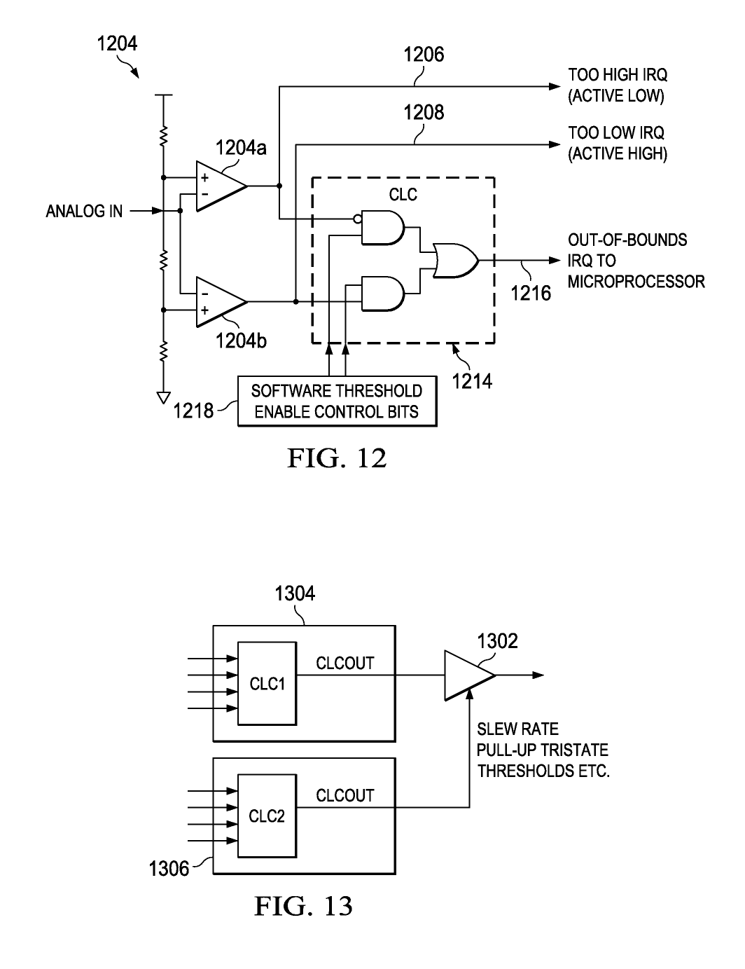

An example using a window comparator 1204 is shown in FIG. 12. As is known, a window comparator compares an input signal with a low and a high reference voltage. It will produce an output of comparator 1204a causing an interrupt 1206 to be generated if the voltage is above the high reference and will produce an output of comparator 1204b causing an interrupt 1208 to be generated if the voltage is below the low reference.

A suitably configured configurable logic cell 1214 can combine the interrupts so that only one interrupt request 1216 is generated. As noted above, the configurable logic cell 1214 can be configured using software in a variety of functions to allow AND, OR, and XOR of up to four signals, including register-based logic (flip flops and latches) that allow for state-memory and sequential machine. In the example illustrated, software threshold enable control bits from, e.g., a control register 1218 are provided as inputs to the configurable logic cell 1214.

In general, the configurable logic cell 1214 can be configured by software, and reconfigured as necessary, or combined with other, similar, configurable logic cells to increase the number of available inputs. In some embodiments, the configurable logic cell 1214 can combine two to four input signals to form a single interrupt to the microprocessor, using various logic functions and other features.

Further, as noted above, it may be desirable to control slew rate/drive strength on output pins. Slew rate is the rate of change of the output voltage with time. As is known, the output drive strength determines the slew rate of the resulting signal (a low drive strength translates to a high slew rate, and vice versa). Typically, these are controlled by individual devices or register control bits acting individually. Some embodiments of configurable logic in accordance with the present invention, however, assign a configurable logic cell to control slew rate (i.e., make it faster or slower) by combining inputs from a plurality of sources, such as the PWM or software.

This is illustrated more particularly in FIG. 13. As shown, a configurable logic cell 1304 provides an output to pin/driver 1302. Instead of a control register, another configurable logic cell 1306 can be assigned to control pin properties, such as drive strength, tristate operation, pull-ups, input thresholds, or other properties.

Thus, the configurable logic cell can combine a number of signals by implementing a logic function, latch, or flip-flop, in a manner similar to that discussed above, to provide a signal that can control the operation of the pin 1302 and thus drive strength, and other properties. In some embodiments, a set of functions is provided to allow AND, OR, and XOR of up to four signals, and also register-based logic (flip flops and latches) that allow for state-memory and sequential machines.

As noted above, the configurable logic cell can be configured by software, and reconfigured as necessary, or combined with other, similar, logic devices to increase the number of available inputs. Thus, as shown, a configurable logic cell according to some embodiments can combine two to four input signals (e.g., from a PWM and software) to form a single signal that can be used to control the drive strength (slew rate) and/or tri-state operation of a microprocessor I/O pin.

While specific implementations and hardware/software configurations for the mobile computing device have been illustrated, it should be noted that other implementations and hardware configurations are possible and that no specific implementation or hardware/software configuration is needed. Thus, not all of the components illustrated may be needed for the mobile computing device implementing the methods disclosed herein.

As used herein, whether in the above description or the following claims, the terms “comprising,” “including,” “carrying,” “having,” “containing,” “involving,” and the like are to be understood to be open-ended, that is, to mean including but not limited to. Only the transitional phrases “consisting of” and “consisting essentially of,” respectively, shall be considered exclusionary transitional phrases, as set forth, with respect to claims, in the United States Patent Office Manual of Patent Examining Procedures.

Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

What is claimed is:

1. A processor, comprising:
a RISC CPU core;
a plurality of peripherals, the plurality of peripherals including a configurable logic cell peripheral;
wherein the configurable logic cell peripheral is configured to combine a plurality of inputs into a single output.

2. A processor in accordance with claim 1, wherein the plurality of inputs comprise I/O ports, oscillator output, system clocks, or peripheral outputs and the single output comprises an I/O port, a peripheral input, or a system clock.

3. A processor in accordance with claim 1, wherein the single output controls drive strength at an output port.

4. A processor in accordance with claim 1, wherein the single output controls slew rate at an output port.

5. A processor in accordance with claim 1, the configurable logic cell programmable to function as one of a plurality of predetermined logic functions.

6. A processor in accordance with claim 1, the configurable logic cell peripheral configurable via one or more software registers.

7. A processor in accordance with claim 1, the configurable logic cell peripheral configurable via non-volatile memory.

8. A processor in accordance with claim 7, wherein the non-volatile memory is statically connected for configuration.

9. A processor in accordance with claim 7, wherein the non-volatile memory is read and configuration data is transferred to configuration registers for configuring the configurable logic cell peripheral.

10. A processor in accordance with claim 1, wherein after initial configuration, the configuration of the configurable logic cell peripheral can be updated via software.

11. A processor, comprising:
a central processing unit (CPU) core;
a plurality of peripherals coupled via one or more buses to the CPU core, the plurality of peripherals including at least one configurable logic cell peripheral;
wherein the configurable logic cell peripheral is configured to combine a plurality of inputs into a single output.

12. A processor in accordance with claim 11, wherein the plurality of inputs comprise I/O ports, oscillator output, system clocks, or peripheral outputs and the single output comprises an interrupt, an I/O port, a peripheral input, or a system clock.

13. A processor in accordance with claim 11, wherein the single output controls drive strength at an output port.

14. A processor in accordance with claim 11, wherein the single output controls slew rate at an output port.

15. A processor in accordance with claim 11, the configurable logic cell programmable to function as one of a plurality of predetermined logic functions.

16. A processor in accordance with claim 11, the configurable logic cell peripheral configurable via one or more software registers.

17. A processor in accordance with claim 11, the configurable logic cell peripheral configurable via non-volatile memory.

18. A processor in accordance with claim 17, wherein the non-volatile memory is statically connected for configuration.

19. A processor in accordance with claim 17, wherein the non-volatile memory is read and configuration data is transferred to configuration registers for configuring the configurable logic cell peripheral.

20. A processor in accordance with claim 11, wherein after initial configuration, the configuration of the configurable logic cell peripheral can be updated via software.

21. A method for use in a processor system, comprising:
setting one or more bits in a control register;
using the one or more bits in the control register to define functions implemented by a configurable logic cell, the functions comprising a plurality of combinatorial and logic function states;
wherein the configurable logic cell is configured to combine a plurality of inputs into a single output.

22. A method in accordance with claim 21, wherein the plurality of inputs comprise I/O ports, oscillator output, system clocks, or peripheral outputs and the single output comprises an I/O port, a peripheral input, or a system clock.

23. A method in accordance with claim 21, wherein the single output controls drive strength at an output port.

24. A method in accordance with claim 21, wherein the single output controls slew rate at an output port.

25. A method in accordance with claim 21, the configurable logic cell programmable to function as one of a plurality of predetermined logic functions.

26. A method in accordance with claim 21, the configurable logic cell peripheral configurable via one or more software registers.

27. A method in accordance with claim 21, the configurable logic cell peripheral configurable via non-volatile memory.

28. A method in accordance with claim 27, wherein the non-volatile memory is statically connected for configuration.

29. A method in accordance with claim 27, wherein the non-volatile memory is read and configuration data is transferred to configuration registers for configuring the configurable logic cell peripheral.

30. A method in accordance with claim 21, wherein after initial configuration, the configuration of the configurable logic cell peripheral can be updated via software.
